(19) United States
(12) Patent Application Publication
(10) Pub. No.: US 2026/0353299 A1
(43) Pub. Date: Nov. 5, 2026

(54) UNIFIED WIRELESS TRANSMIT/RECEIVE UNIT POWER SAVING

(71) Applicant: InterDigital Patent Holdings, Inc., Wilmington, DE (US)

(72) Inventors: Chia-Hung Wei, Chesterbrook, PA (US); Faris Alfarhan, Montreal (CA); Ghyslain Pelletier, Montreal (CA); Samuli Turtinen, Ii (FI); Keiichi Kubota, Setagaya-Ku (JP); Martino Freda, Laval (CA); Tuong Hoang, Montreal (CA); Brian Martin, Farnham (GB)

(73) Assignee: InterDigital Patent Holdings, Inc., Wilmington, DE (US)

(21) Appl. No.: 19/199,052

(22) Filed: May 5, 2025

(51) Int. Cl. H04W 52/02; H04W 72/0446; H04W 76/28; H04W 88/06

(52) U.S. Cl. CPC H04W 52/0258; H04W 72/0446; H04W 76/28; H04W 88/06

(57) ABSTRACT

A wireless transmit/receive unit operating in a cellular network may be configured with a unified power savings mechanism. The unified power savings mechanism may define three or more modes of operation, including an ultra-low (UL) power mode, a partial-connectivity (PC) mode, and a full-connectivity (FC) mode. In the UL mode, the WTRU may use a low power wake up radio (LR) to monitor for low power wake up signals (LP-WUS). In the PC mode, the WTRU may use its main radio to send and/or receive transmissions. In the FC mode, the WTRU may use its main radio to send and/or receive transmissions and may operate pursuant to a discontinuous reception (DRX) cycle. The WTRU in PC mode may monitor a different (e.g., smaller) control channel than the WTRU would in FC mode, for example, to save power. PC mode may also require less reference signal measurement and/or reporting overhead.

### BACKGROUND

A control channel may refer to a channel which carries control information. A wireless transmit/receive unit (WTRU) may monitor one or more control channels. For example, in 5G, the WTRU may monitor a physical downlink control channel (PDCCH).

A low power signal may refer to a signal sent by the network (NW) to indicate to the WTRU to turn on a main radio (MR) and/or to wake-up or to resume to general PDCCH monitoring. For example, in 5G, the low power signal is known as the low power wake up signal (LP-WUS).

A WTRU may employ power saving mechanisms. A power saving mechanism may refer to an algorithm for adaptation or reduction of WTRU processing and power consumption. For example, in 5G, discontinuous reception (DRX) is a power saving mechanism.

### SUMMARY

Apparatuses (e.g., wireless transmit/receive units (WTRUs)) and/or methods may include unified power saving mechanisms support: granularizing power consumption management on layer 1 (L1) and/or layer 2 (L2) procedures. The unified power savings mechanisms may be based on dynamically switching among multiple power saving modes to achieve power saving gains for different quality of service (QoS) requirements. Discontinuous reception (DRX) procedures may be dynamically disabled while power saving mode switching. Apparatuses and methods described herein may enable management of control channel monitoring for retransmission.

Unified power savings mechanisms may support features for granularizing power consumption management on L1/L2; dynamic switching of power saving configuration; and/or control channel monitoring management without DRX. Related procedures and functions may include low power wake up signal (LP-WUS), connected mode DRX (C-DRX); and/or control channel monitoring.

Apparatuses and methods as described herein may be configured for dynamic power saving configuration switching via low power signal, conditional power saving configuration switching, and/or skipping Control channel monitoring for retransmission.

A WTRU may comprise a processor, memory, a low power wake up receiver or radio (LR), and/or a main radio (MR). The WTRU may use the LR to monitor for LP-WUS while operating in a low power mode. The low power mode may be associated with the WTRU being configured to receive one or more signals from the network using the LR.

The WTRU may determine to switch to a partial-connectivity (PC) mode. For example, the WTRU may determine to switch to the PC mode based on an indication received from the network. The PC mode may be characterized by the WTRU using its MR but not using a discontinuous reception (DRX) cycle. The WTRU, while operating in the PC mode, may monitor a first control channel. The first control channel may be associated with a first set of time domain radio resources and a first set of frequency domain resources.

The WTRU may determine to switch to a full connectivity (FC) mode. For example, the WTRU may determine to switch to the FC mode based on an amount of uplink data available for transmission exceeding a threshold. The FC mode may be characterized by the WTRU operating in a DRX cycle and using the MR. In the FC mode, the WTRU may monitor a second control channel using the MR. The second control channel may be associated with a second set of time and/or frequency domain radio resources.

The WTRU may receive configuration information for power saving mechanisms. The configuration information may include a set of configurations for the PC mode. The set of configurations for the PC mode may include two or more alternative configurations for the PC mode. The WTRU may determine an alternative configuration to use based on a condition occurring. For example, if the WTRU is switching from the low power mode, it may determine to use a first alternative configuration of the set of configurations, but if the WTRU is switching from the FC mode, then it may determine to use a second alternative configuration of the set of configurations.

The configuration information may include configurations for the low power mode, the PC mode, and/or the FC mode. The configuration information for the FC mode may include DRX parameters associated with the DRX cycle of the FC mode. The configuration for the PC mode and the configuration for the FC mode may each include time and/or frequency domain radio resources, associated with the first and/or second control channels.

The WTRU may manage transmission configuration indicator (TCI) states differently in the FC mode as opposed to the PC mode. For example, the configuration for the PC mode may identify a first set of TCI states to monitor in PC mode, whereas the configuration for the FC mode identifies a second set of TCI states to monitor in FC mode.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a block diagram illustrating an example of low power receiver (LR) to main radio (MR) switching.

FIG. 3A is a timing diagram illustrating an example of physical downlink control channel (PDCCH) monitoring for downlink retransmission (reTx).

FIG. 3B is a timing diagram illustrating an example of PDCCH monitoring for uplink reTx.

FIG. 4 is a block diagram illustrating an example of switching between ultra-low (UL) power, partial connectivity (PC), and full connectivity (FC) modes.

FIG. 5 is a system diagram illustrating an example of a power saving mechanism.

FIG. 6A, FIG. 6B, and FIG. 6C are system diagrams illustrating examples of additional or alternative power saving mechanisms.

FIG. 7 is a timing diagram illustrating an example, wherein a WTRU switches to a PC mode for a first period of time after a second period of time.

FIG. 8 is a timing diagram illustrating an example, wherein a WTRU remains in the PC mode for a minimal number of control channel monitoring occasions (MOS).

FIG. 9 is a timing diagram illustrating an example, wherein the WTRU skips control channel monitoring.

### DETAILED DESCRIPTION

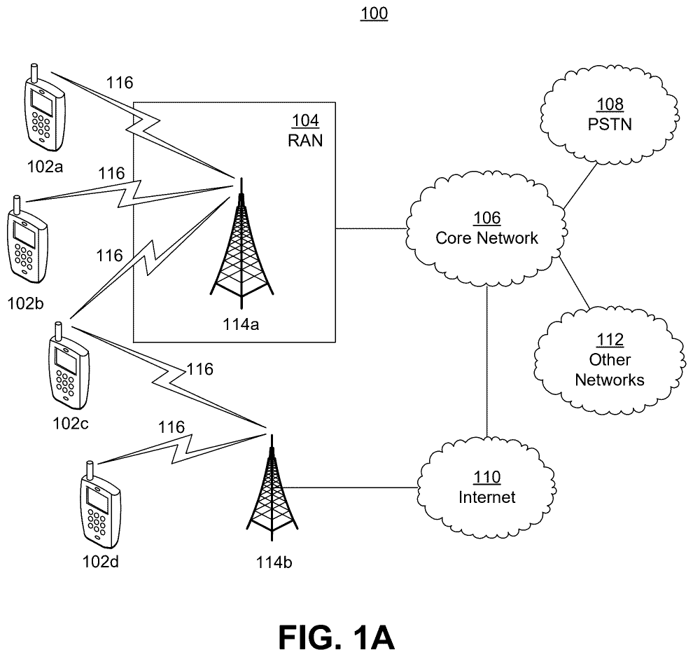

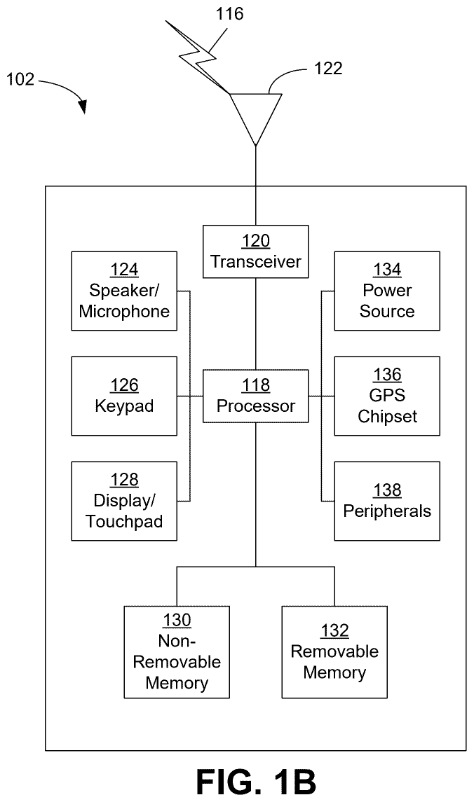

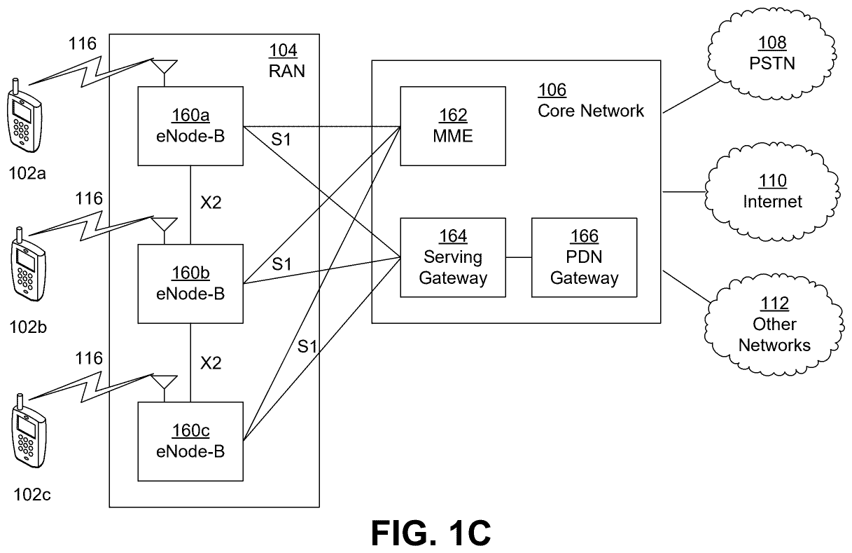

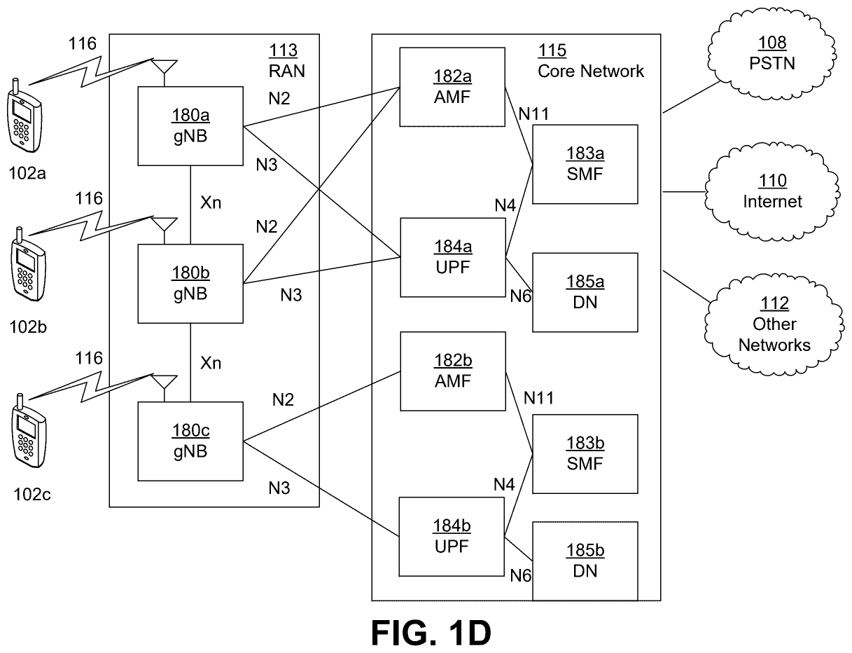

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS).

The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In discontinuous reception (DRX), a wireless transmit/receive unit (WTRU) is configured to periodically wake up at least once per DRX cycle for physical downlink control channel (PDCCH) monitoring (e.g., blind decoding). This monitoring causes power consumption. To avoid unnecessary PDCCH monitoring, in cases where there is no downlink data for the WTRU, a wake up signal (WUS) may be used (e.g., as a power saving mechanism).

an (e.g., RRC_CONNECTED) WTRU may be configured by a Network (NW) to monitor a WUS referred to as downlink control information of power saving (DCP). In examples, DCP may comprise, downlink control information (DCI) with cyclic redundancy check (CRC) bits scrambled by power saving radio network temporary identifier (PS-RNTI). The WTRU may monitor for the DCP in a DCP MO (Monitoring Occasion) which is located a time offset (e.g., configured via a parameter, ps-Offset) before each DRX cycle (e.g., before each starting time of drx-on Duration Timer).

The WTRU may be indicated by the DCP to skip waking up for a DRX cycle, for example, if no downlink data reception is needed. For example, the WTRU may be indicated by the DCP to skip triggering the drx-onDuration Timer before a DRX cycle. As a result, the WTRU may skip the PDCCH monitoring driven by the drx-onDuration Timer running

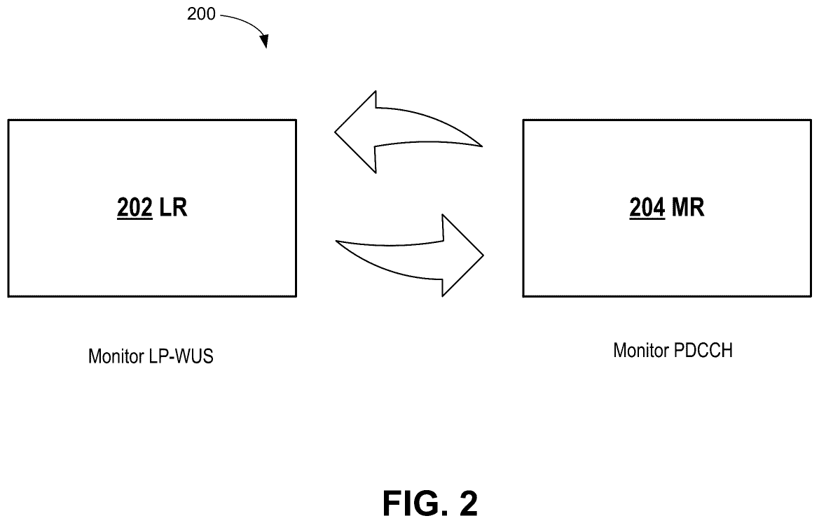

To further increase power saving gains, low power wake up signals (LP-WUSs) may be used. In LP-WUS mechanisms, a WTRU may be equipped with a with a main radio (MR) module for general data reception/transmission and a low power wake up receiver or radio (LP-WUR (LR)) module for monitoring LP-WUS in LP-WUS MO(s). The terms receiver and radio are used interchangeably herein. The LR may have lower power consumption characteristics compared to the MR. As illustrated in FIG. 2, the WTRU may switch between using the LR and the MR. For example, the WTRU may be configured to periodically monitor LP-WUS via LR and then turn on the MR for data reception/transmission once the LP-WUS is detected. In other words, the MR can be turned off or set to deep sleep mode for power saving until a LP-WUS is detected by LR.

FIG. 2 shows an example of LR to MR switching at 200. A WTRU may use the LR 202 to monitor for an LP-WUS. The WTRU may receive an LP-WUS. The WTRU may determine to switch to a different power mode. The other mode may be configured such that the WTRU uses an MR 204 while in the other mode. The WTRU may switch to the MR 204 to monitor the PDCCH.

A WTRU may be configured to perform PDCCH monitoring for data retransmission (re Tx). The WTRU may monitor for data retransmissions using the MR.

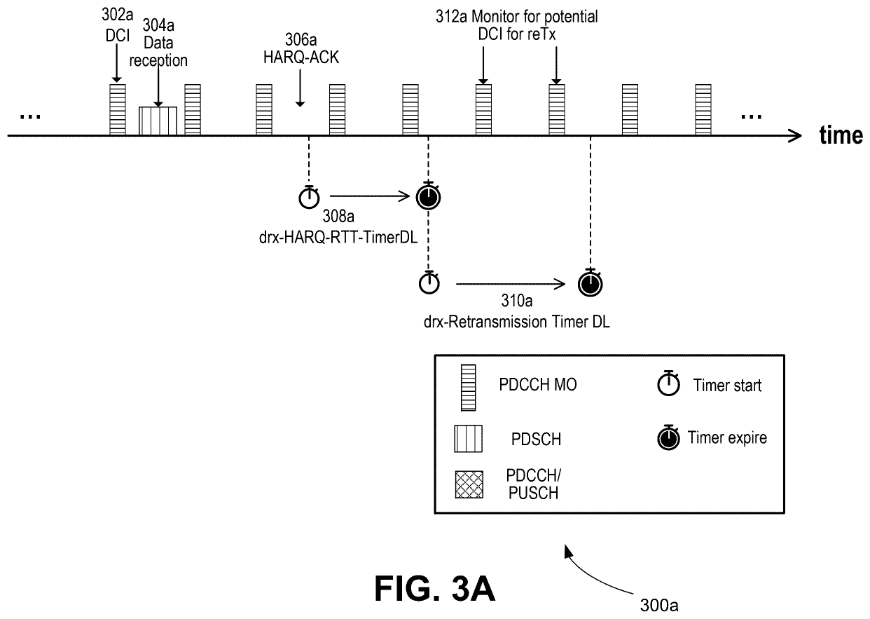

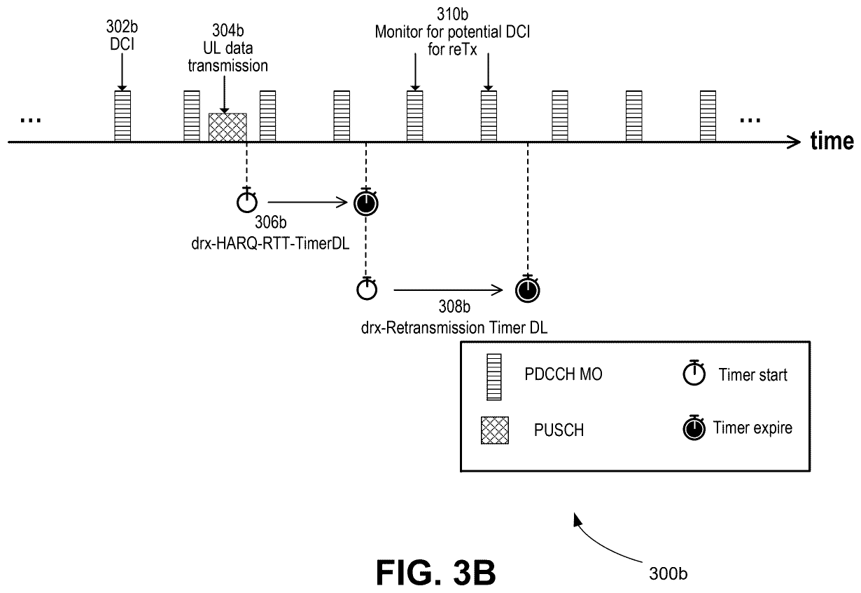

In DRX, as illustrated in FIG. 3A at 300a, after a WTRU receives a physical downlink shared channel (PDSCH) scheduled by a DCI, the WTRU may perform hybrid automatic repeat request (HARQ) feedback on a PUCCH and/or a PUSCH. At 302a, the WTRU may receive a DCI which schedules a data reception. At 304a, the WTRU may perform the data reception on the PDSCH. At 306a, the WTRU may send a HARQ NACK or ACK. At 308a, the WTRU may trigger a downlink (DL) DRX round trip time (RTT) timer right after the WTRU finishes the uplink (UL) feedback (e.g., the first symbol after the UL transmission carrying the HARQ-ACK). At 310a, a DL DRX Retransmission timer may be triggered in response to the expiration of the DL DRX RTT timer. At 312a, the WTRU may monitor the PDCCH (e.g., stay in DRX Active time) to detect potential DCI transmissions which schedule the PDSCH retransmission.

FIG. 3B shows an example of a similar case for an uplink (dynamic grant) at 300b. At 302b, the WTRU may receive a DCI scheduling an UL data transmission. At 304b, the WTRU may perform the UL data retransmission on an uplink resource (e.g., PUSCH). After performing a transmission on the UL resource (e.g., PUSCH) indicated by a dynamic grant, at 306b an UL DRX RTT timer may be triggered. For example, the UL DRX DRR timer may be triggered in the first symbol after the WTRU finishes the UL transmission. At 308b, a UL DRX Retransmission timer may be triggered in response to the UL DRX RTT timer expiring. At 310b, the WTRU may monitor control channel (e.g., stay in DRX Active time) to detect potential DCI transmissions which schedule the UL resource for retransmission.

In the case of an Uplink Configured grant, a UL DRX RTT timer may be triggered after the first transmission (e.g., within a bundle) on the UL resource (e.g., PUSCH) configured by configured grant. A UL DRX Retransmission timer may be triggered in response to the UL DRX RTT timer expiring. The WTRU may monitor the PDCCH (e.g., stay in DRX Active time) to detect potential DCI transmissions which schedule the UL resource for retransmission.

The initial value of a timer may be numerology dependent.

DRX related timers and/or parameters can be configured with different units individually. For example, timers and/or parameters can be configured using units of absolute time (e.g., ms and 1/32 ms). Examples include, but are not limited to drx-onDurationTimer, drx-Inactivity Timer, drx-ShortCycle, and/or drx-SlotOffset.

Timers and/or parameters can be configured with numerology dependent length (e.g., based on symbols and/or slots). Examples include but are not limited to drx-HARQ-RTT-TimerDL, drx-HARQ-RTT-TimerUL, drx-Retransmission TimerDL, and/or drx-Retransmission TimerUL. The exact length of the numerology dependent timer may dynamically be determined for each dynamic DL data reception and UL data transmission based on the numerology of corresponding bandwidth parts (BWPs).

A WTRU can be configured to wake up if DCP is not properly detected, (e.g., using ps-WakeUp).

LP-WUS can operate together with C-DRX. In examples, a WTRU may be configured to monitor LP-WUS MO(s), by using its LR. The WTRU may determine (e.g., based on the LP-WUS) whether to wake up to monitor the PDCCH using its MR (e.g., for each DRX cycles).

Once the WTRU is woken up by the LP-WUS for data reception, the subsequent PDCCH monitoring can then be controlled by DRX functionality (e.g., drx-onDuration Timer, drx-Inactivity Timer, drx-ShortCycle and etc.).

DL reference signal (RS) measurement reporting for channel status estimation purposes can be coupled with DRX operation as a function of the type of channel state information (CSI) report (i.e., aperiodic, periodic and semi-persistent); and/or DRX active/non-active time.

A WTRU and a NW can use unified WTRU and NW power saving mechanisms. The power saving mechanisms may include combinations or variations of C-DRX, LP-WUS, and/or Cell discontinuous transmission (DTX).

C-DRX, LP-WUS, and/or cell DTX energy savings mechanism can be used in a variety of use cases. In examples, C-DRX may drive other processing components, energy consumption modules, resource usage, resource monitoring, measurements and reporting, and/or etc. LP-WUS (e.g., configuration or property) may be used to indicate one or more access type, scheduling, measurement. For example, LP-WUS may be subject to C-DRX, such that C-DRX drives LP-WUS, or vice versa. For example, C-DRX may be subject to LP-WUS, such that LP-WUS drives C-DRX.

Unified power saving mechanisms may include dynamic scaling to enable fast transmission (Tx) and/or reception (Rx) of data bursts. The data bursts may be of variable sizes.

The low power signal monitoring may or may not drive DRX operation and DRX may or may not drive LP-WUS monitoring.

A WTRU can comprise an LR, an MR, or both an LR and an MR. The LR can be used for low power signal monitoring. The MR can be used for control channel monitoring and UL/DL data transmission/reception.

Unified power saving mechanisms can include physical layer mechanisms. For example, on-off keying (OOK)-based low power signal may be used. The low power signal can (e.g., explicitly or implicitly) include and/or indicate functionality information to the WTRU (e.g., small functionality information). For example, the functionality information may include one or more access types, scheduling information, RS measurements, bandwidth (BW) or BWP information, and/or an index of a configuration.

Low power signals can be used to modify or adapt parameters for control channel monitoring without C-DRX. For example, low power signals can be used for changing the Bandwidth, resource, intensive, and/or candidate to be monitored.

Low power signals can be used to modify or adapt parameters for other procedures. For example, a low power signal can be used to control or modify the RS measurement report (e.g., by dynamically enabling and/or disabling DRX).

DL data reception and UL data transmission can be assigned and scheduled by the control channel.

Unified power saving mechanisms can include algorithms and/or methods. A WTRU may use algorithms and/or methods to reduce processing and/or power consumption. C-DRX procedures are examples of algorithms and/or methods that can reduce processing and/or power consumption. The algorithms and/or methods may affect the WTRU's behavior in one or more domains (e.g. time, frequency, hardware, spatial domains).

LP-WUS procedures and/or DRX procedures may drive PDCCH monitoring and vice versa. For example, the WTRU may determine to monitor the LP-WUS depending on the PDCCH. The WTRU may determine to monitor the PDCCH depending on the LP-WUS. In some cases, both LP-WUS and C-DRX may be used together. However C-DRX and LP-WUS are not required to be used together. For example, C-DRX may be used without LP-WUS. LP-WUS procedures may be used without C-DRX procedures. C-DRX procedures may be used jointly with LP-WUS procedures. In examples, C-DRX procedures may be subject to (e.g., controlled by LP-WUS) LP-WUS. C-DRX procedures may be dynamically applied by a WTRU while using the main radio (MR).

A WTRU may be scheduled in power saving mode without C-DRX timers and/or C-DRX procedures.

DRX can drive one or more functions. C-DRX scaling can enable functions and/or associated parameters to be scaled. C-DRX scaling can be based on cycle length, data activity, PDCCH decoding level, PDCCH resource usage (e.g., aggregation level/coresets/blind decoding etc.), and/or criteria of decoding PDCCH.

Unified power saving mechanisms may enable adaptive adjustability of the power consumption level for services having different QoS requirements. Unified power saving mechanisms can enable a WTRU to handle low power signal monitoring, control channel monitoring, and/or RS measurement reporting.

Unified power saving mechanisms can enable a WTRU to perform efficient monitoring of control channels for potential data retransmissions without DRX (e.g., or with DRX as a complementary alternative in some scenarios). The WTRU may continue control channel monitoring after data transmission/reception. The WTRU may monitor control channels for data reTx.

Due to poor cell coverage, a WTRU may experience the low power signal miss detection. Unified power saving mechanisms can enable WTRUs to wake up for data reception when experiencing low coverage.

Unified power saving mechanisms may comprise three or more power saving modes. Each power saving mode may have different power consumption levels. The WTRU may switch from mode to mode among the three or more power saving modes to achieve power saving gains for different QoS requirements.

The power saving modes may include, for example, a low or ultra Low-power (UL) mode: applying LR only; a Partial-Connectivity (PC) mode: applying MR without DRX; and a Full-Connectivity (FC) mode: applying MR with DRX. Each power saving mode may have a corresponding configuration. The WTRU, while in different power saving modes, applies different power saving mode specific configurations when performing (e.g., lower layer) procedures. The procedures may include, for example, control channel monitoring and/or reference signal measurement reporting. Each power saving mode specific configuration may drive WTRU behaviors differently.

For example, the WTRU may use either the LR or the MR, depending on which power saving mode the WTRU is in.

The WTRU may monitor low power signal, limited control channel or full control channel, depending on the power saving mode. The WTRU may perform different intensive levels of control channel monitoring, depending on the power saving mode. For example, the WTRU may enable or disable DRX, or use different control channel monitoring configurations, based on the power saving mode. The WTRU may perform different levels of beam management and channel state information reference signal (CSI/RS) measurement reports, depending on the power saving mode.

The WTRU can dynamically switch among these three power saving modes based on pre-defined condition(s) and/or based on being instructed by NW.

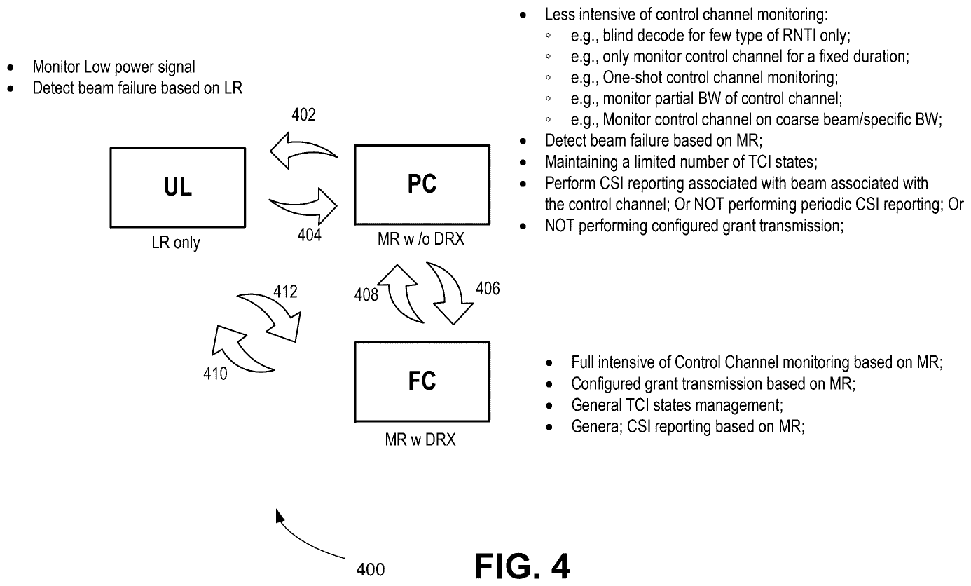

FIG. 4 shows examples of mode transitions and behaviors of a WTRU in each of a UL, PC, and FC mode at 400.

A WTRU comprising an LR and an MR may receive (e.g., via radio resource control (RRC) signaling), configuration information, from a network (NW). The configuration information may comprise one or more of the following.

The configuration information may comprise a UL configuration for UL mode. The UL configuration for UL mode may include one or more of the following. The UL configuration may include low power signal MO(s) periodicity and duration(s). The UL configuration may include a low power signal miss detection threshold;

The configuration information may comprise a PC configuration for PC mode. The PC configuration for PC mode may include one or more of the following.

The PC configuration may include a first control channel monitoring configuration.

The first control channel monitoring configuration may include a first list of RNTI to be blind decoded and/or a first list of search space to be received. The first control channel monitoring configuration may include a first control channel resource configuration indicating a first BW for control channel monitoring.

The PC configuration may include a first control channel time span configuration. The first control channel time span configuration may include a first period of time which indicates a minimal time the WTRU should monitor control channel.

The PC configuration may include a PC specific TCI state configuration. The PC configuration may include a PC mode transition configuration. The PC mode transition configuration, for example, may include a data volume threshold which indicates a minimal data volume needs to be transmitted.

The configuration information may comprise a FC configuration for FC mode. The FC configuration for FC mode may include one or more of the following.

The FC mode configuration may include a second control channel monitoring configuration. The second control channel monitoring configuration may include a second list of RNTI to be blind decoded and a second list of search space to be received. The second control channel monitoring configuration may include a second control channel resource configuration indicating a second BW for control channel monitoring.

The FC mode configuration may include a set of scheduling parameters or assumptions (e.g., control channel monitoring occasions, CSI measurements/reporting, operational BW, UL and DL data resources to assume). The FC mode configuration may include a second control channel time span configuration. The second control channel time span configuration may include one or more DRX parameters, for example, initial value(s) for DRX duration/cycle related timers.

The WTRU, when operating in UL mode, may use the LR to monitor low power signals (e.g., in one or more MO(s) based on the UL configuration). If a low power signal is not detected in a configured low power signal MO, the WTRU may determine that a low power signal miss has occurred. The WTRU may count the number of misses of low power signals, and/or the number of detected low power signals. The WTRU may receive an indication to skip monitoring for one or more low power signal Mos.

At 404, the WTRU (e.g., in UL mode) may determine to switch to PC mode based on one or more of the following events. The WTRU may determine to switch to PC mode based on detecting a low power signal in a low power signal MO. The WTRU may determine to switch to PC mode based on a number of missing detected low power signals (e.g., in low power signal MOs) being equal or larger than a threshold (e.g., a low power signal miss detection threshold). The WTRU may determine to switch to PC mode based on detecting beam failure associated with the LR.

The WTRU, while operating in the PC mode, may use the MR to perform control channel monitoring, RS measurement reporting, and/or beam management, based on PC configuration.

At 406, the WTRU (e.g., in PC mode) may determine to switch to FC mode based on one or more of the following events.

The WTRU may determine to switch to FC mode based on data traffic demand aspect. For example, the WTRU may be configured to switch to FC mode if an amount of UL data that needs to be transmitted is equal or higher than a data volume threshold.

The WTRU may determine to switch to FC mode based on beam failure based at the MR.

The WTRU may determine to switch to FC mode based on a signal received from a network. For example, the WTRU may be indicated by the gNB, via the DCI, that more data needs to be received. The WTRU may determine to switch to FC mode based on this indication.

The WTRU may determine to switch to FC mode based on temporary L1 measurement and reporting being triggered. The WTRU may determine to switch to FC mode based on L2 reconfiguration being triggered. The WTRU may determine to switch to FC mode based on if, before switching from UL to PC, the number of missed of low power signal is equal to or higher than the first low power signal miss detection threshold.

The WTRU, operating in FC mode, may use the MR to perform control channel monitoring, RS measurement reporting, beam management, and/or Periodic UL transmission (e.g., based on the FC configuration).

A WTRU in PC mode may perform one or more of the following actions. The WTRU may perform control channel monitoring. Monitoring control channel may be based on the first control channel monitoring configuration and/or the first control channel time span configuration. The WTRU may perform RS measurement reporting. For example, measuring RSs associated with a DL beam applied for the low power signal monitoring and performing measurement reporting. The WTRU may perform Beam management. For example, the WTRU may maintain a limited number of TCI states (e.g., and monitor QCL properties based on corresponding RS).

A WTRU in FC mode may perform one or more of the following actions. The WTRU may perform control channel monitoring. For example, the WTRU may perform control channel monitoring based on the second control channel monitoring configuration and/or the second control channel time span configuration. The WTRU may perform RS measurement reporting. For example, the WTRU may perform measurement of one or more of RS which are activated by RS report config activation MAC CE. The WTRU may perform Beam management. For example, the WTRU may maintain (e.g., all) activated TCI. The WTRU may perform periodic UL transmission. For example, the WTRU may determine the configured grant resource is valid to be transmitted and perform a transmission in accordance with the figured grant

A WTRU may be capable of operating in multiple power saving modes. For example, the power saving mechanisms described herein may include multiple power saving modes.

To maximize WTRU power saving gains in wireless communication systems, WTRUs may employ power saving mechanisms as discussed herein. The power saving mechanisms may be implemented by the WTRU and the NW to manage the power consumption from one or more procedures. The WTRU and the NW may manage power consumption for one or more procedures based on a multiple power saving model. For example, a power saving mechanism may define multiple power saving modes logically. Each power saving mode may correspond to different types of WTRU behavior for one or more procedures. Examples of procedures which are elaborated below. The one or more of procedures may include but are not limited to one or more of the following.

The one or more of procedures may include control channel monitoring. The control channel monitoring may include WTRU blind decoding of the signal received on the control channel.

The one or more of procedures may include beam management (e.g., TCI state maintenance). The TCI state maintenance may include the WTRU monitoring source RSs of the TCI state to meet a TCI state application delay. For example, the WTRU may perform source RS tracking procedure to estimate an indicated type of QCL property based on the received source RS of the TCI state.

The one or more of procedures may include low power signal monitoring, detecting, receiving. The one or more of procedures may include downlink RS monitoring/receiving.

The WTRU may receive configuration information for multiple power saving modes. For example, the configuration information may be received from a network via RRC signaling. The configuration information may include one or more power saving mode associated configuration(s).

A power saving mechanism may be operated based on an associated power saving configuration. For example, a WTRU may be configured via the configuration information with a power saving configuration to be applied for the power saving mechanism. Specifically, the power saving configuration may be applied by the WTRU for the one or more procedures.

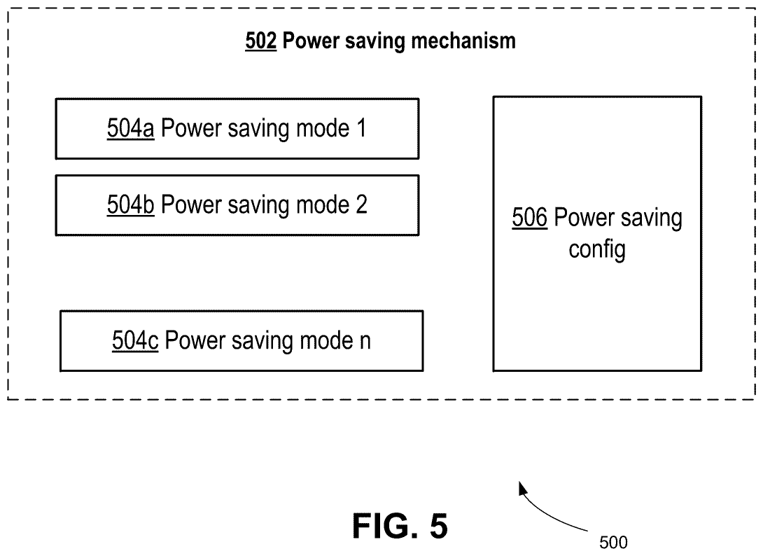

FIG. 5 shows an illustration of a power saving mechanism that includes multiple power saving modes and configuration information at 500. The power saving mechanism 502 includes a plurality of power saving modes (e.g., 504a, 504b, 504c). The power saving mechanism 502 includes power saving configuration information 506.

There are multiple ways of implementing the power saving configuration illustrated in FIG. 5. Several nonlimiting examples are discussed below.

In one implementation, each power saving mode is associated with a configuration or set of configurations to be applied by the WTRU for the one or more procedures. Different power saving modes may be configured to be associated with different configurations or sets of configurations for the one or more of procedures.

For example, a WTRU may be configured with a first configuration or set of configurations associated with a first power saving mode. The WTRU may also be configured with a second configuration or set of configurations associated with a second power saving mode.

The WTRU may apply the first configuration or set of configurations for the one or more procedures while in the first power saving mode, and the WTRU may apply the second configuration or set of configurations for the one or more procedures while in the second power saving mode.

Additionally, or alternatively, two or more power saving modes may share a set of one or more common configurations but each of the two or more power saving modes has its own dedicated set of one or more configurations. The WTRU in a power saving mode may apply (e.g., parameters from) both the sets of common configurations and the dedicated configurations for the one or more procedures while in the power saving mode.

For example, a WTRU may be configured with a first set of one or more configurations to be associated with both first and second power saving modes. The WTRU may be configured with a second set of one or more configurations to be associated with the first power saving mode and be configured with a third set of one or more configurations to be associated with the second power saving mode. The first set of configurations may be shared among the first and the second power saving modes. However, the second set of configurations is dedicated to the first power saving mode, and the third set of configurations is dedicated to the second power saving mode. The WTRU may apply both first and second sets of configurations for the one or more procedures while in the first power saving mode. The WTRU may apply both first and third sets of configurations for the one or more procedures while in the first power saving mode.

The configurations may be configured by the NW via dedicated RRC signaling and/or broadcast system information. In an example, a first subset of configurations is configured via the dedicated RRC signaling and a second subset of configurations is configured via the broadcast system information. In another example, a subset of configurations is configured via the broadcast system information and may be reconfigured via dedicated signal. In another example, a subset of configurations is configured via the dedicated signal and may be reconfigured via broadcast system information.

Additionally, or alternatively, each power saving mode may be configured to be associated with more than one configuration or set of configurations to be applied by the WTRU for the one or more procedures. Different power saving modes may be configured to be associated with different configurations or sets of configurations for the one or more of procedures.

For example, a WTRU may be configured with two sets of configurations associated with a first power saving mode. The WTRU may also be configured with two sets of configurations associated with a second power saving mode.

In examples, a power saving mode can be associated with a first set of one or more configurations and a second set of one or more configurations. The WTRU may dynamically and/or conditionally determine which set of configurations to be applied by the WTRU for the one or more procedures.

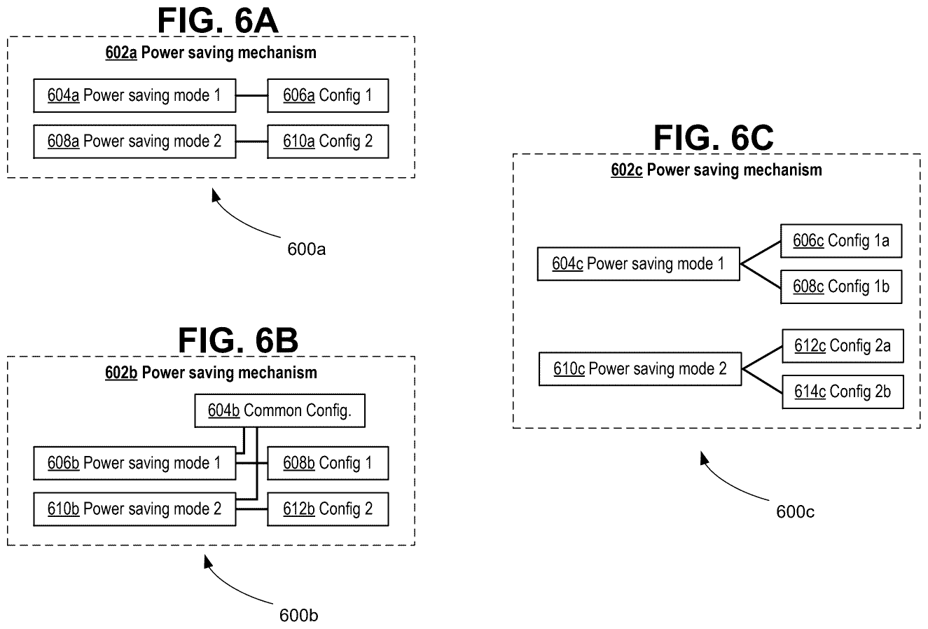

FIG. 6A, FIG. 6B, and FIG. 6C are examples showing alternative ways of linking power saving configurations with power saving modes, as discussed herein, at 600a, 600b, and 600c. In FIG. 6A, the power saving mechanism 602a includes a first power saving mode 604a which is associated with a first configuration 606a, and a second power saving mode 608a which is associated with a second configuration 610a. In FIG. 6B, the power saving mechanism 602b includes a common configuration 604b. The common configuration is associated with a first power saving mode 606b and a second power saving mode 610b. The first power saving mode 606b is also associated with a first configuration 608b, and the second power saving mode 610b is also associated with a second configuration 612b. In FIG. 6C, the power saving mechanism 602c includes a first power saving mode 604c and a second power saving mode 610c. The first power saving mode 604c is associated with a first set of alternative configurations, 608c and 606c. The second power saving mode 610c is associated with a second set of alternative configurations, 612c and 614c.

A WTRU may perform configuration selection to choose which configuration to use for a power saving mode. The WTRU may be configured with multiple sets of power saving configurations as disclosed earlier in the present disclosure. The WTRU may dynamically apply different sets of power saving configurations for the one or more procedures.

In examples, the WTRU may dynamically apply different sets of one or more power saving configurations for the one or more of procedures based on which power saving mode is being used (e.g., which powers saving mode the WTRU is currently in). For example, in the case of the power saving configuration shown in the example of FIG. 6A at 600a, the WTRU may apply the power saving configuration 1 for the one or more of procedures when the WTRU is in the power saving mode 1. The WTRU may apply the power saving configuration 2 for the one or more procedures when the WTRU is in the power saving mode 2. For example, in the case of the power saving configuration shown in the example of FIG. 6B at 600b, the WTRU may apply both a common power saving configuration and the power saving configuration 1 for the one or more of procedures when the WTRU is in the power saving mode 1. The WTRU may apply both the common power saving configuration and the power saving configuration 2 for the one or more procedures when the WTRU is in the power saving mode 2.

In examples, the WTRU may dynamically apply different sets of power saving configurations for the one or more of procedures based on at least a configuration indicator received from the network. For example, in the case of the power saving configuration shown in the example of FIG. 6C at 600c, a WTRU in the power saving mode 1 (e.g., 604c) may apply the power saving configuration 1a (e.g., 606c) for the one or more procedures in response to the WTRU being indicated (e.g., by the configuration indicator) to apply the power saving configuration 1a (e.g., 606c). The WTRU may apply the power saving configuration 1b (e.g., 608c) for the one or more procedures in response to the WTRU being indicated (e.g., by the configuration indicator) to apply the power saving configuration 1b (e.g., 608c). The WTRU in the power saving mode 2 (e.g., 610c) may apply the power saving configuration 2a (e.g., 612c) for the one or more procedures in response to the WTRU being indicated (e.g., by the configuration indicator) to apply the power saving configuration 2a (e.g., 612c). The WTRU may apply the power saving configuration 2b (e.g., 614c) for the one or more of procedures in response to the WTRU being indicated (e.g., by the configuration indicator) to apply the power saving configuration 2b (e.g., 614c). It is noted that the configuration indicator may be carried by, for example, a RRC message, a downlink MAC CE, a DCI, or any other message received from the NW.

In examples, the WTRU may be configured as shown in FIG. 6C at 600c. While the WTRU is in the power saving mode 1 (e.g., 604c), the WTRU may receive a power saving mode switching indicator indicating the WTRU to switch from the power saving mode 1 (e.g., 604c) to the power saving mode 2 (e.g., 610c). The power saving mode switching indicator may explicitly carry a configuration indicator. The WTRU may determine to apply either configuration 2a (e.g., 612c) or 2b (e.g., 614c), after switching to the power saving mode 2 (e.g., 610c), based on at least the configuration indicator. That is, the configuration indicator may indicate WTRU to apply either the configuration 2a (e.g., 612c) or 2b (e.g., 614c).

In examples, a WTRU in a power saving mode may determine to apply one of multiple sets of power saving configuration (e.g., associated with the power saving modes) based on the event triggering the WTRU switching to the power saving mode.

For example, the WTRU can be configured with multiple configurations or sets of power saving configurations for a power saving mode. Each of the multiple configurations or sets of power saving configurations may be associated with different events. The WTRU may determine to apply one of the multiple sets of power saving configuration based on the event triggers the WTRU to switch to the first power saving.

For example, in case of the power saving configuration shown in the example of FIG. 6C at 600c, the power saving configuration 2a (e.g., 612c) may be associated with event A, whereas power saving configuration 2b (e.g., 614c) is associated with event B. The WTRU may determine to switch to power saving mode 2 (e.g., 610c) in response to either event A or event B, the WTRU may determine to apply the power saving configuration 2a (e.g., 612c) or 2b (e.g., 614c) accordingly.

In examples, the WTRU may be in power saving mode 2 (e.g., 610c), in case of the power saving configuration as shown in the example of FIG. 6C at 600c. The power saving configuration 2a (e.g., 612c) is associated with event A and the power saving configuration 2b (e.g., 614c) is associated with event B. The WTRU is in the power saving mode 2 (e.g., 610c), the WTRU may determine to switch to power saving configuration 2a (e.g., 612c) in response to the event A is satisfied (e.g., event A happened or occurred). The WTRU may determine to switch to power saving configuration 2b (e.g., 614c) in response to the event B is satisfied. For example, the power saving configuration 2a (e.g., 612c) is associated with downlink data arrival (e.g., the WTRU needs to turn ON the MR to receive DL data) and the power saving configuration 2b (e.g., 614c) is associated with uplink data available for transmission (e.g., WTRU has data available to be transmitted in the buffer, and the WTRU needs to turn ON the MR to transmit it). Stated another way, downlink data arrival may correspond to event A, whereas uplink data becoming available for transmission corresponds to event B. The WTRU may determine to apply the power saving configuration 2a (e.g., 612c) in response to determining the downlink data arrived. Similarly, the WTRU may determine to apply the power saving configuration 2b (e.g., 614c) in response to determining the uplink data is available to be transmitted.

The downlink data arrival may be determined by the WTRU based on a low power signal received by the WTRU via the LR. The low power signal may indicate that the WTRU is to switch from power saving mode 1 (e.g., 604c) to power saving mode 2 (e.g., 610c). The low power signal may also indicate to the WTRU the downlink data arrival by the low power signal. Similarly, the WTRU may determine to switch from power saving mode 1 (e.g., 604c) to power saving mode 2 (e.g., 610c) in response to uplink data becoming available for transmission. Also, the WTRU may determine to apply power saving configuration 2b (e.g., 614c) in response to uplink data becoming available for transmission.

WTRU behavior in different power saving modes is now considered.

In examples, a power saving mechanism may include three power saving modes: low or Ultra Low-power (UL) mode, Partial-Connectivity (PC) mode and Full-Connectivity (FC) mode. A WTRU in each of the three power saving modes may perform one or more procedures differently. Specifically, the WTRU may apply different power saving configurations while the WTRU is in different power saving modes.

The WTRU in UL mode may turn ON a low power radio module (LR) to monitor a low power signal on one or more low power signal monitor occasion(s) and turn OFF the main radio module (MR).

The WTRU in PC mode may turn ON the MR to perform one or more procedure(s) at a lesser intensive level to save power consumption. In examples, the WTRU in PC mode may not enable DRX operation in PC mode. For example, the WTRU may not trigger a drx-onDuration Timer, a DRX long/short cycle related timer and/or any timer triggered by new data transmission (e.g., drx-Inactivity Timer). The WTRU in PC mode may, without limitation, perform one or more behaviors listed as following.

The WTRU in PC mode may monitor control channels (e.g., PDCCH) at a less intensive level. For example, the WTRU may monitor control channels based on a first control channel monitoring configuration which is configured by the NW for the PC mode. The first control channel monitoring configuration may, for example, be carried by the power saving configuration associated with the PC mode The first control channel monitoring configuration may be different than a second control channel monitoring configuration which is configured by the NW, via a power saving configuration associated with the FC mode, for the FC mode. It is noted that the first control channel monitoring configuration may include but is not limited to include one or more of the following.

The first control channel monitoring configuration may include a set of one or more time domain radio resource(s) (e.g., periodicity, time span, specific symbol/sub-slot/slot/subframe durations) for an associated control channel. The WTRU may monitor the associated control channel.

The first control channel monitoring configuration may include a set of one or more frequency domain radio resource(s) (e.g., range(s) of subcarrier/frequency band/carrier(s), bandwidth (part) or cells) for an associated control channel. The WTRU may monitor the control channel.

The first control channel monitoring configuration may include a set of one or more time domain and/or frequency domain radio resource(s) associated with one or more specific DL beam. The DL beam may correspond to a DL transmission associated with particular TCI state(s). The time domain radio resource(s) may comprise a number of time(s) the WTRU needs to monitor the control channel on the frequency domain radio resource(s).

The first control channel monitoring configuration may include a list of types of RNTI. The WTRU may use the RNTIs to blind decode on the monitored control channel which is determined based on at least the specific time domain resources and the specific frequency domain resources.

The WTRU in PC mode may maintain TCI states at a less intensive level, as compared with FC mode, for example. Maintaining a TCI state may comprise activating a TCI state, monitoring a source RS of the TCI state for estimating specific type of QCL properties, monitoring a source RS of the TCI state to meet a latency requirement for a channel transmission/reception. For example, the WTRU may maintain a first list of TCI states which is configured by the NW for the PC mode. The first list of TCI states may be configured/indicated by at least the power saving configuration associated with the PC mode. In examples, the WTRU may be configured with multiple TCI states for the PC mode via the power saving configuration associated with the PC mode. The WTRU may be further indicated to maintain a subset of TCI states of the first list of TCI states. The WTRU may maintain the subset of TCI states while the WTRU in PC mode. The first list of TCI states may be different than a second list of TCI states which is configured by the NW, via a power saving configuration associated with the FC mode, for the FC mode.

The WTRU may perform DL RS (e.g., CSI-RS/SSB) measurement and reporting by applying one or more RS measurement report configuration(s). The one or more RS measurement report configurations may be indicated by the power saving configuration associated with the PC mode. The one or more RS measurement report configuration(s) may be different than the RS measurement report configuration(s) applied by the WTRU in FC and/or UL mode.

In examples, the WTRU is configured with multiple RS measurement report configurations by the NW. The WTRU may determine to perform RS measuring and reporting based on a subset of the configured multiple RS measurement report configurations. The subset of the configured multiple RS measurement report configurations may be determined based on at least the power saving configuration and/or the list of TCI states which are maintained by the WTRU in the FC mode.

For example, a WTRU may be configured with a list of RS measurement report configurations by NW (e.g., for the PC mode). Each RS measurement report configuration may correspond to an RS. The RSs may be associated with different TCI states. The WTRU may determine (e.g., be indicated by the NW) to maintain a subset of the list of RS measurement report configurations. The subset may be determined, by the WTRU, based on the RS measurement report configuration-associated TCI states and the TCI state(s) which the WTRU is maintaining in the FC mode. For example, the WTRU may perform RS measuring and reporting by applying the subset of RS measurement report configurations for which the corresponding RS is associated with the TCI state(s) maintained by the WTRU in the FC mode.

The WTRU may enable partial C-DRX procedures in the PC mode. For example, the WTRU may enable part of DRX related timers, for example one or multiple of the drx-onDuration Timer, drx-Inactivity Timer, drx-ShortCycle, drx-SlotOffset, drx-HARQ-RTT-TimerDL, drx-HARQ-RTT-TimerUL, drx-Retransmission TimerDL, and/or drx-Retransmission TimerUL.

For example, the WTRU may only enable drx-InactivityTimer for extending control channel monitoring. In another example, the WTRU may also enable drx-HARQ-RTT-TimerDL, drx-HARQ-RTT-TimerUL, drx-Retransmission TimerDL, and/or drx-Retransmission TimerUL for handling control channel monitoring for potential data retransmission.

In another example, the WTRU may be configured with different sets of DRX configurations including DRX parameters (e.g., initial values for each timer) via different power saving configurations associated with the PC power saving mode (e.g., as shown in the example in FIG. 6C at 600c). The WTRU may dynamically determine to apply one of the multiple sets of DRX configurations based on a configuration indicator and/or a power saving mode switching indicator. For example, either the configuration indicator and/or the power saving mode switching indicator may indicate one of the multiple sets of DRX configurations.

The WTRU in FC mode may turn ON the MR to perform one or more procedure(s) at a full intensive level to support more aggressive QoS requirements. The WTRU in FC mode may perform one or more behaviors discussed below.

The WTRU in FC mode may monitor control channels at a full intensive level. For example, the WTRU may monitor control channel based on a second control channel monitoring configuration which is configured by the NW for the PC mode. The second control channel monitoring configuration may be carried by the power saving configuration associated with the FC mode. The second control channel monitoring configuration may include but is not limited to include one or more of the following.

The second control channel monitoring configuration may include a set of one or more time domain radio resource(s) (e.g., periodicity, time span, specific symbol/sub-slot/slot/subframe durations) for an associated control channel. The WTRU may monitor the associated control channel.

The second control channel monitoring configuration may include a set of one or more frequency domain radio resource(s) (e.g., range(s) of subcarrier/frequency band/carrier(s), bandwidth (part) or cells) for an associated control channel. The WTRU may monitor the associated control channel.

The second control channel monitoring configuration may include time domain and/or frequency domain radio resource(s) associated with one or more specific DL beam. The DL beam may correspond to a DL transmission associated with particular TCI state(s).

The second control channel monitoring configuration may include a list of types of RNTI. The WTRU may use the RNTIs to blind decode on the monitored control channel which is determined based on at least the time domain resources and the frequency domain resources.

The control channel monitoring configuration may, in examples, be a control channel monitoring configuration configured by the NW to be applied by the WTRU in RRC_CONNECTED mode (e.g., as in 5G).

The WTRU in FC mode may maintain TCI states at a full intensive level. For example, the WTRU may maintain a list of TCI states which is configured by the NW and activated by the NW via a DL MAC CE for RRC_CONNECTED.

The WTRU may enable a C-DRX procedure for control channel monitoring.

A WTRU may perform switching among power saving modes.

As illustrated in FIG. 4 and as discussed more fully herein, the WTRU may dynamically switch from one power saving mode to another power saving mode based on one or more conditions and/or an instruction from the NW. The one or more conditions and/or the instruction from the NW are considered more fully below.

At 404, the WTRU may switch from UL mode to PC mode. The WTRU may switch from UL mode to PC mode based on one or more of the following.

The WTRU may switch from UL mode to PC mode based on detecting one or more low power signal in one or more MO(s). The WTRU may switch from UL mode to PC mode based on detecting a low power signal in a MO. In examples, the low power signal may indicate that the WTRU is to switch the power saving mode to PC mode.

The WTRU may switch from UL mode to PC mode based on the WTRU accumulating or counting a number of times the low power signal has been missed (i.e., WTRU didn't detect low power signal in the MO). For example, the WTRU may switch from UL mode to PC mode based on the counted number of misses exceeding a threshold.

The WTRU may switch from UL mode to PC mode based on the WTRU accumulating or counting a number of times the low power signal has been missed in consecutive MO.

The WTRU may switch from UL mode to PC mode based on the accumulated or counted number of missed (e.g., consecutive) low power signals being equal to or higher than a threshold. The threshold may be preconfigured by the NW via, for example, the UL or the PC associated power saving configurations.

The WTRU may switch from UL mode to PC mode based on a beam failure being detected based on RS monitoring via LR.

The low power signal may be used to indicate a UL-to-FC mode transition to the WTRU. The low power signal which indicated UL-to-FC mode transition may further include one or more of the following.

The low power signal may include configuration information comprising one or multiple sets of power saving configurations associated with the PC mode. In examples, the configuration information in the low power signal may indicate that the WTRU is to use a long cycle or a short cycle.

The low power signal may include a number of control channel occasion(s) for the WTRU to monitor. For example, the WTRU may switch back to UL if there is no DL reception scheduled, or if UL data needs to be transmitted. In examples, one or more field(s) of the low power signal may indicate a specific duration.

At 406, the WTRU may perform switching from PC mode to FC mode. The WTRU may switch from PC mode to FC mode based on one or more of the following.

The WTRU may switch from PC mode to FC mode based on an amount of UL data available for transmission (e.g., in the L2 buffer) being equal to or higher than a first threshold. The first threshold may be configured by the NW either via the power saving configuration associated with either PC mode or FC mode. In examples, the threshold may apply for UL data associated with a particular set of radio bearer(s), set of QoS flows, and/or set of QoS requirements. For example, the WTRU may determine to transition from PC mode to FC mode if the amount of UL data associated with a particular set of radio bearers, QoS flows, or QoS requirements that are available for transmission becomes equal to or higher than the first threshold which configured by the NW either via the power saving configuration associated with either PC mode or FC mode.

The WTRU may switch from PC mode to FC mode based on detecting a beam failure based on RS monitoring via MR.

The WTRU may switch from PC mode to FC mode based on the WTRU transmitting a HARQ feedback to the NW in response to a DL data reception.

The WTRU may switch from PC mode to FC mode based on the WTRU transmitting a HARQ NACK to the NW in response to a DL data reception.

The WTRU may switch from PC mode to FC mode based on the WTRU transmitting a HARQ feedback/NACK to the NW in response to a DL data reception a number of times.

The WTRU may switch from PC mode to FC mode based on one or more L2 related procedure(s) being triggered. For example, the WTRU may switch from PC mode to FC mode based on an L2/L3 reconfiguration message being received and/or L2/L3 reconfiguration being triggered.

The WTRU may switch from PC mode to FC mode based on the WTRU being indicated by the gNB (e.g., via the DCI) that there are more data to be received.

The WTRU may switch from PC mode to FC mode based on L1 measurement and reporting being triggered.

The WTRU may switch from PC mode to FC mode if, before switching from UL to PC, the number of missed detect low power signal was equal to or higher than the first low power signal miss detection threshold.

The WTRU may switch from PC mode to FC mode based on WTRU triggering a buffer status report (BSR) and/or scheduling request (SR).

The WTRU may switch from PC mode to FC mode based if neither a switch back (e.g., to UL) indicator nor a DCI is received within a number of control channel occasions.

The WTRU may switch from PC mode to FC mode if there is no valid PUCCH resource for either SR or HARQ-feedback.

The WTRU may switch from PC mode to FC mode based on other event(s) occurring or being triggered. For example, the WTRU may switch from PC mode to FC mode if the BWP is switched, or if an RRC state is triggered for transitioning.

The WTRU may switch from PC mode to FC mode based on the WTRU receiving a PC-to-FC mode transition indication from the NW. The transition indication may be included in one or more field(s) carried by the DCI scheduling PDSCH. For example, the transition indication may be included in DCI 1_X which schedules PUSCH reception, and/or DCI 2_X which schedules PDSCH reception.

The transition indication may be included in an individual DCI different from the DCI scheduling the PDSCH. For example, the transition indication may be included in a specific format of DCI. The transition indication may be included in any other L2 indicator schedules by other DCI (e.g., DL MAC CE).

The PC-to-FC mode transition indication may further include configuration information comprising one or multiple sets of power saving configurations associated with the FC mode. The configuration information comprised in the PC-to-FC mode transition may further include an indication that the WTRU is to apply a long cycle or a short cycle.

At 408, the WTRU may switch from FC mode to PC mode. At 410, the WTRU may switch from FC mode to UL mode. The WTRU may switch from FC mode to PC mode or UL mode based on one or more of the following.

The WTRU may switch from FC mode to PC or UL mode if a first period of time has elapsed since the WTRU switched to the FC mode. The WTRU may switch from FC mode to PC or UL mode if the WTRU receives a FC-to-PC mode transition indication from the NW. The WTRU may switch from FC mode to PC or UL mode if a beam failure recovery procedure has been successfully completed. The WTRU may switch from FC mode to PC or UL mode if a L2/L3 reconfiguration procedure has been completed. The WTRU may switch from FC mode to PC or UL mode if the WTRU completed UL transmission of data in the buffer.

At 412, the WTRU may perform switching from UL mode to FC mode. The WTRU may switch from UL mode to FC mode based on one or more of the following.

The WTRU may switch from UL mode to FC mode if an amount of UL data available for transmission (e.g., in the L2 buffer) is equal to or higher than a second threshold. The second threshold may be configured by the NW either via the power saving configuration associated with either the PC mode or the FC mode. In examples, the threshold may apply to UL data associated with particular set of radio bearer(s), set of QoS flows, and/or set of QoS requirements. For example, the WTRU may determine to switch from UL mode to FC mode if an amount of data associated with a particular set of radio bearers, QoS flows, and/or QoS requirements is available for transmission has equal to or higher than a second threshold configured by the NW either via the power saving configuration associated with either PC mode or FC mode.

The WTRU may switch from UL mode to FC mode based on detecting a low power signal in a MO. The low power signal may indicate that the WTRU is to switch the power saving mode to FC mode.

The WTRU may switch from UL mode to FC mode based on a beam failure being detected based on RS monitoring via LR.

At 402, a WTRU may perform switching from PC mode to UL mode. The WTRU may switch from PC mode to UL mode based on one or more of the following.

The WTRU may switch from PC mode to UL mode based on a second period of time elapsing since the WTRU switched to the PC mode. The WTRU may switch from PC mode to UL mode based on receiving a DCI and/or MAC CE indicating the switching from PC to UL. The WTRU may switch from PC mode to UL mode based on receiving an RRC message reconfiguring L2/L1 parameters and the WTRU successfully finishing the reconfiguration.

The WTRU may monitor for data retransmissions. While the WTRU is in the PC mode, the WTRU may not enable the DRX procedure. The WTRU may determine when and how to monitor the control channel for potential DL data retransmission.

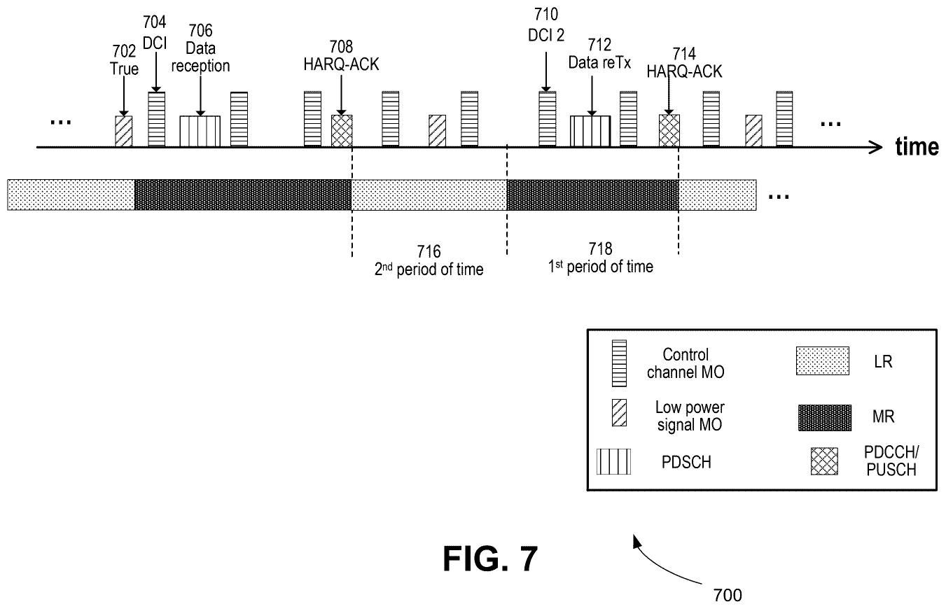

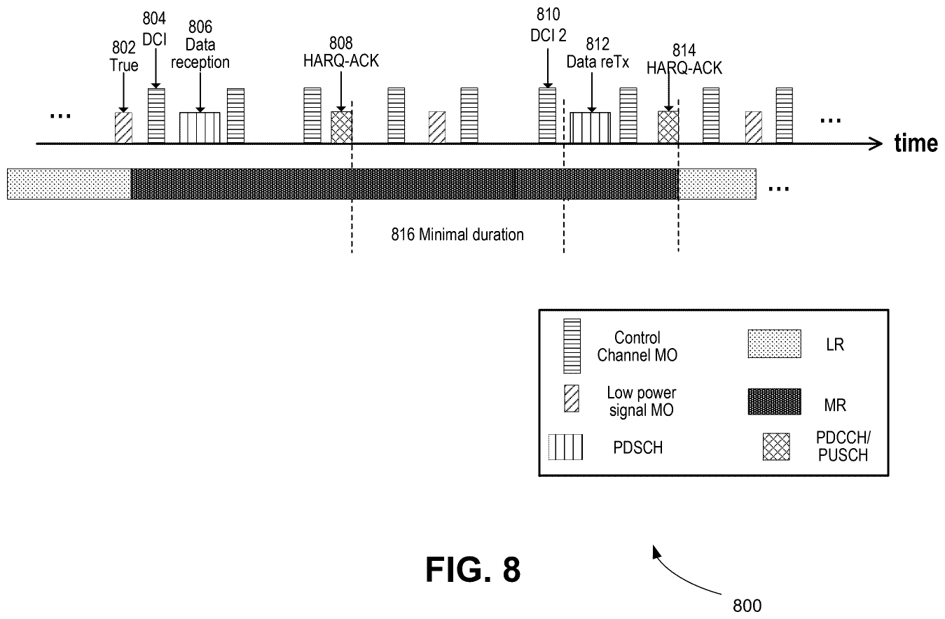

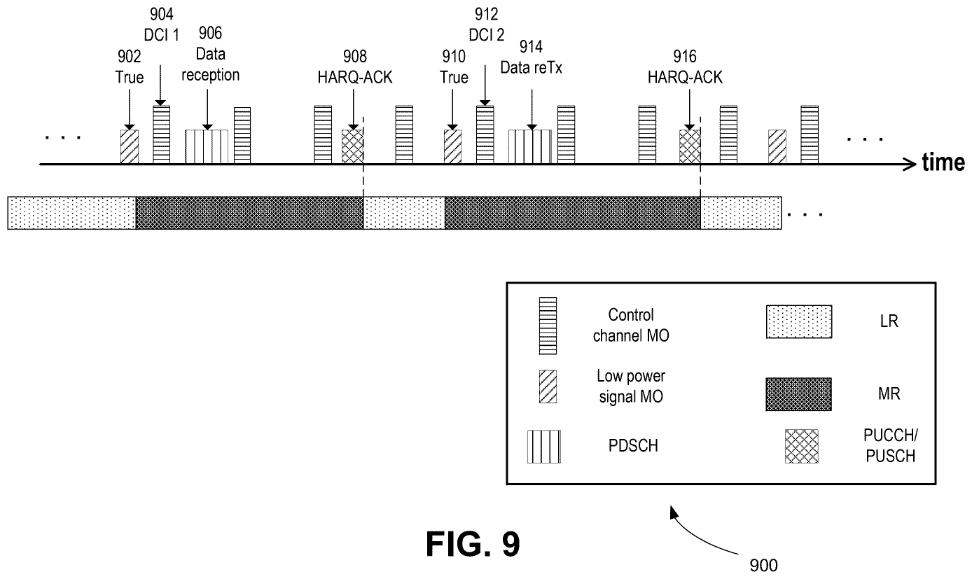

The LR notation in the FIG. 7, FIG. 8, and FIG. 9 indicates the time during which the WTRU is in UL mode and applying its LR for low power signal monitoring.

The MR notation in FIG. 7, FIG. 8, and FIG. 9 indicates the time during which the WTRU is in PC mode and applying its MR for control channel monitoring.

A DL case is now considered, with reference to FIG. 7. A WTRU may switch to PC for a first period of time after a second period of time. The two periods of time may be either pre-configured; or dynamically indicated by DCI scheduling the PDSCH.

As illustrated in FIG. 7 at 700, the WTRU may be configured by the NW with a first length of time and a second length of time via the power saving configuration associated with the PC mode. At 702, the WTRU may detect a low power signal and switch from UL to PC mode. While applying MR to monitor control channel, at 704 the WTRU may receive a first DCI, DCI 1, which schedules a DL data reception. At 706, the WTRU may accomplish the DL data reception via its MR and perform HARQ feedback accordingly (e.g., at 708) on UL channels (e.g., PUCCH/PUSCH). The WTRU may switch to the UL mode for a second period of time 716 which is determined based on at least the configured second length of time. The WTRU may determine to switch back to PC mode, to monitor control channel for potential DL data retransmission, after the second period of time 716 has elapsed since switching to UL mode. After the WTRU switches back to PC mode, the WTRU may monitor the control channel for a first period of time 718, by applying the power saving configuration (e.g., control channel monitoring configuration) associated with the PC mode. The WTRU may receive a second DCI at 710. The second DCI may schedule a data retransmission. The WTRU may use the MR to receive the retransmitted DL data at 712, and perform HARQ feedback at 714.

In examples, the WTRU may skip control channel monitoring during the 1st period of time. The WTRU may receive the DL data retransmission using a specific radio resource. The specific radio resource may be determined by the WTRU based on the 1st DCI and/or the 1st DL data reception. The frequency domain resource of the 1st DL data and the retransmitted DL data may be the same. The time interval between the control channel transmitting the 1st DCI and the 1st DL data may be the same as the time interval between the first control channel within the 1st period of time and the DL data retransmission.

In examples, the WTRU may determine to switch back to UL from PC in based on the WTRU retransmitting HARQ ACK for the corresponding DL data.

In examples, the WTRU may be configured with a first control channel monitoring configuration and a second control channel monitoring configuration to be applied for the PC mode. For example, the first control channel configuration may be applied by the WTRU if the UL to PC mode transition is not for receiving data retransmission (e.g., the UL to PC mode transition is triggered by general low power signal detection). The second control channel configuration may be applied by the WTRU if the UL to PC mode transition is for receiving data retransmission.

Additionally, or alternatively, with reference to FIG. 8, a WTRU may be indicated, via the DCI which scheduled the PDSCH, of a minimal duration the WTRU should keep awake. For example, the minimal duration may be defined by a minimum number of control channel MOs that the WTRU is to stay awake for.

FIG. 8 shows an example wherein a WTRU is configured with a minimum duration at 800. As the scenario illustrated in FIG. 8, a WTRU (e.g., in the UL mode) detects a low power signal at 802. The WTRU then determines to switch to PC mode. The WTRU may turn on its MR for control channel monitoring. At 804, the WTRU receives DCI 1 which schedules a DL data reception. The WTRU may receive the DL data at 806. In response to the DL data reception, the WTRU transmits a HARQ NACK or ACK to the NW at 808. The WTRU may determine to stay in the PC mode for at least a period of time (e.g., the minimal duration 816 illustrated in the FIG. 8) after the WTRU finishes the HARQ ACK transmission. For example, the WTRU may keep monitoring the control channel via the MR for at least the period of time defined by the minimal duration 816. The period of time may be configured by the NW via the power saving configuration associated with the PC mode. In examples, the period of time may be dynamically indicated by the NW via a DCI (e.g., the DCI 1) and/or the low power signal which the WTRU detected. The WTRU may be preconfigured with multiple options of the minimal duration 816. The WTRU may be dynamically indicated with one of the multiple options, by the NW via the DCI (e.g., DCI 1) or the low power signal. The WTRU may select and apply the indicated option of the minimal duration for the control channel monitoring for potential data retransmission scheduling. At 810, the WTRU may receive a second DCI (e.g., DCI 2) that schedules a data retransmission. At 812, the WTRU may receive the data retransmission. At 814, the WTRU may transmit a HARQ ACK to the NW.

WTRU behavior in UL cases is now considered. A WTRU may be configured by the NW with a first length of time and a second length of time via the power saving configuration associated with the PC mode. The WTRU may detect a low power signal and switch from UL mode to PC mode. The WTRU may use its MR to monitor the control channel. The WTRU may receive DCI 1 which schedules a UL data transmission. The WTRU may send the UL data transmission and switch to the UL mode for a second period of time which is determined based on at least the configured second length of time. The WTRU may determine to switch back to PC mode, to monitor control channel for a potential UL grant for the UL data retransmission, after the second period of time has elapsed since switched to UL mode. After the WTRU switches back to PC, the WTRU may monitor the control channel, for a first period of time, by applying the power saving configuration (e.g., control channel monitoring configuration) associated with the PC mode. The WTRU may use the MR to retransmit UL data.

Additionally, or alternatively, a WTRU (e.g., in the UL mode) may detect a low power signal and then determine to switch to PC mode. The WTRU may turn on its MR for control channel monitoring. The WTRU may receive a DCI 1 which grants a UL resource for a UL data transmission. In response to finishing the UL data transmission, the WTRU may determine to stay in the FC mode for at least a period of time (e.g., the minimal duration). For example, the WTRU may keep monitoring the control channel via the MR for at least the period of time. The period of time may be configured by the NW via the power saving configuration associated with the PC mode.

An example of dynamic determination of power saving configuration in a WTRU is now considered. A WTRU may perform one or more of the following actions or steps.

The WTRU may receive configuration information (e.g., via RRC signaling) from a NW. The configuration information may include a UL configuration for low power signal monitoring. The UL configuration for low power signal monitoring may include at least: a first low power signal MO configuration (e.g., long duration) and/or a second low power signal MO configuration (e.g., short duration). The configuration information may include a PC configuration for Control channel monitoring.

The WTRU may monitor a control channel, using its MR, based on the PC configuration.

The WTRU may receive, using its MR, a first DCI, on the control channel. The first DCI may schedule a first data channel reception. The first DCI may carry scheduling information for one or more potential retransmissions of the first data channel (e.g., a time offset/frequency allocation).

The WTRU may receive, using its MR, the first data channel. The WTRU may transmit, using its MR, corresponding HARQ feedback to the NW.

In response to the HARQ feedback, the WTRU may determine to monitor low power signal MO(s), using its LR, by applying either the first or the second low power signal MO configurations based on the HARQ feedback. For example, the WTRU may apply the first low power signal RO configuration if the HARQ feedback was an ACK and apply the second low power signal RO configuration if the HARQ feedback was a NACK. For another example, the WTRU may apply the first low power signal RO configuration for a period of time and then switch to the second low power signal RO configuration.

The WTRU may receive, using its MR, a second data channel transmission in response to receiving a low power signal transmitted on a low power signal MO. The low power signal MO may be determined based on the second low power signal MO configuration. The second data channel may be received based on the scheduling information for one or more potential retransmissions of the first data channel and the location of the low power signal MO.

In examples, the WTRU may skip control channel monitoring and receive the second data channel directly if the WTRU is woken up by the low power signal which is transmitted on the second low power signal MO indicated by the second low power signal MO configuration. This may enable the WTRU to save power consumption on the control channel monitoring.

FIG. 9 comprises an illustration of an example of control channel skipping at 900. At 902, the WTRU may receive a low power WUS, and may switch to the PC mode and activate its MR. At 904, the WTRU may receive a first DCI (e.g., DCI 1) which schedules a data reception. At 906, the WTRU may receive the data. At 908, the WTRU may transmit HARQ feedback to the NW. The WTRU may then switch to UL mode and monitor low power signal MO via LR. The WTRU may be indicated by the NW via the low power signal (e.g., at 910) to switch to PC mode for receiving the data retransmission. The WTRU may switch back to the PC mode. At 912, the WTRU may receive a second DCI (e.g., DCI 2). The WTRU may receive the retransmitted data at 914 and may send HARQ feedback at 916. The WTRU may use its MR to receive the retransmitted data without using the MR to monitor control channel MO. For example, the WTRU may not need to receive the DCI 2 at 912.

In examples, the WTRU may determine the radio resource (e.g., time/frequency) of the retransmitted data based on the data reception which scheduled by the DCI 1. For example, the WTRU may use the same frequency carriers, bands, and/or BWP as data scheduled by DCI 1. The time interval between the reTx data and a specific control channel monitoring MO may be equal to the time interval between DCI 1 and data scheduled by the DCI 1. The specific control channel monitoring MO may be a first MO after a low power signal MO (e.g., at 902 or 910) or a specific MO after the low power signal MO indicated by the low power signal.

In examples, the WTRU may be indicated by the low power signal of whether to skip the control channel MO for the data reTx. Additionally, or alternatively, the DCI 1 may indicate whether to skip the control channel MO and/or indicate a specific number of control channel MOs the WTRU should monitor after switching to PC mode.

The WTRU may determine to flush a HARQ buffer associated with the data scheduled by the DCI according to the low power signal monitoring and/or after a number of cycles. For example, the WTRU may flush the buffer after a specific number of low power signal MOs, if the WTRU didn't detect low power signal to wake up. For example the WTRU may be indicated to flush the buffer via the low power signal.

The WTRU may determine to flush its HARQ buffer according to the low power signal monitoring and/or after a number of cycles.

The DCI 1 may indicate amounts of low power signal/control channel. This may enable low power signal monitoring considering HARQ process specific re Tx.

1. A wireless transmit/receive unit (WTRU) comprising:
a processor, memory, and one or more transceivers, wherein the processor is configured to:
monitor for a low power wake up signal (LP-WUS) in a low-power mode, wherein the low-power mode is characterized by the WTRU being configured to receive one or more LP-WUS signals from a network;
determine to switch from the low power mode to a partial-connectivity mode, wherein the partial-connectivity mode is characterized by the WTRU being configured to send and receive signals and characterized by the WTRU not using a discontinuous reception (DRX) cycle;
monitor a first control channel in the partial-connectivity mode, wherein the first control channel is associated with a first set of time domain radio resources and a first set of frequency domain radio resources;
determine to switch from the partial-connectivity mode to a full-connectivity mode, wherein the full-connectivity mode is characterized by the WTRU being configured to send and receive signals and also characterized by the WTRU using a DRX cycle; and
monitor, pursuant to the DRX cycle, a second control channel in the full-connectivity mode, wherein the second control channel is associated with a second set of time domain radio resources and a second set of frequency domain radio resources.

2. The WTRU of claim 1, wherein the processor is further configured to:
receive configuration information comprising a set of configurations for the partial-connectivity mode, the set of configurations for the partial-connectivity mode comprising a first alternative configuration for the partial-connectivity mode and a second alternative configuration for the partial-connectivity mode.

3. The WTRU of claim 2, wherein the processor is configured to determine to use the first alternative configuration for the partial-connectivity mode based on the WTRU being in the low-power mode or based on an indication received from a network.

4. The WTRU of claim 1, wherein the one or more transceivers comprise a low-power wake up radio and a main radio, wherein the low-power mode is characterized by the WTRU being configured to receive the one or more LP-WUS signals using the low-power wake up radio,
wherein the partial-connectivity and full-connectivity modes are characterized by the WTRU being configured to send and receive signals using the main radio.

5. The WTRU of claim 1, wherein the processor is configured to:
determine to switch to the partial-connectivity mode based on receiving a signal from a network, the signal comprising an indication to switch to the partial-connectivity mode, or determine to switch to the partial connectivity mode based on a determination that a LP-WUS transmission has been missed.

6. The WTRU of claim 1, wherein the processor is configured to receive configuration information comprising a configuration for the low-power mode, a configuration for the partial-connectivity mode, and a configuration for the full-connectivity mode.

7. The WTRU of claim 6, wherein the configuration for the full-connectivity mode indicates one or more DRX parameters associated with the DRX cycle.

8. The WTRU of claim 6, wherein the configuration for the partial-connectivity mode indicates the first set of time domain radio resources and the first set of frequency domain radio resources associated with the first control channel, and wherein the configuration for the full-connectivity mode indicates the second set of time domain radio resources and the second set of frequency domain radio resources associated with the second control channel, wherein the configuration for the partial-connectivity mode indicates a first set of transmission configuration indicator (TCI) states, and the configuration for the full-connectivity mode indicates a second set of TCI states.

9. The WTRU of claim 1, wherein the processor is configured to determine to switch, from the partial-connectivity mode to the low power mode for a first period of time, and switch back to the partial-connectivity mode after the first period of time.

10. The WTRU of claim 1, wherein the processor is configured to determine to switch to the full-connectivity mode, based on an amount of uplink data available for transmission being equal to or higher than a threshold value.

11. A method to be performed by a transmit/receive unit (WTRU), the method comprising:
monitoring for a low power wake up signal (LP-WUS) in a low-power mode, wherein the low-power mode is associated with the WTRU receiving one or more signals from a network;
determining to switch from the low power mode to a partial-connectivity mode, wherein the partial-connectivity mode is characterized by the WTRU sending and receiving signals and characterized by the WTRU not using a discontinuous reception (DRX) cycle;
monitoring a first control channel in the partial-connectivity mode, wherein the first control channel is associated with a first set of time domain radio resources and a first set of frequency domain radio resources;
determining to switch from the partial-connectivity mode to a full-connectivity mode, wherein the full-connectivity mode is characterized by the WTRU sending and receiving signals and also characterized by the WTRU using a DRX cycle; and
monitoring, pursuant to the DRX cycle, a second control channel in the full-connectivity mode, wherein the second control channel is associated with a second set of time domain radio resources and a second set of frequency domain radio resources.

12. The method of claim 11, further comprising:
receiving configuration information comprising a set of configurations for the partial-connectivity mode, the set of configurations for the partial-connectivity mode comprising a first alternative configuration for the partial-connectivity mode and a second alternative configuration for the partial-connectivity mode.

13. The method of claim 12, further comprising determining to use the first alternative configuration for the partial-connectivity mode based on the WTRU being in the low-power mode or based on an indication received from a network.

14. The method of claim 11, wherein the WTRU comprises a low-power wake up radio and a main radio, wherein the low-power mode is characterized by the WTRU being configured to receive the one or more LP-WUS signals using the low-power wake up radio,
wherein the partial-connectivity and full-connectivity modes are characterized by the WTRU being configured to send and receive signals using the main radio.

15. The method of claim 11, further comprising determining to switch to the partial-connectivity mode based on receiving a signal from a network, the signal comprising an indication to switch to the partial-connectivity mode, or determining to switch to the partial connectivity mode based on a determination that a LP-WUS transmission has been missed.

16. The method of claim 11, further comprising receiving configuration information comprising a configuration for the low-power mode, a configuration for the partial-connectivity mode, and a configuration for the full-connectivity mode.

17. The method of claim 16, wherein the configuration for the full-connectivity mode indicates one or more DRX parameters associated with the DRX cycle.

18. The method of claim 16, wherein the configuration for the partial-connectivity mode indicates the first set of time domain radio resources and the first set of frequency domain radio resources associated with the first control channel, and wherein the configuration for the full-connectivity mode indicates the second set of time domain radio resources and the second set of frequency domain radio resources associated with the second control channel, wherein the configuration for the partial-connectivity mode indicates a first set of transmission configuration indicator (TCI) states, and the configuration for the full-connectivity mode indicates a second set of TCI states.

19. The method of claim 11, further comprising switching, from the partial-connectivity mode to the low power mode for a first period of time, and switching back to the partial-connectivity mode after the first period of time.

20. The method of claim 11, further comprising determining to switch to the full-connectivity mode, based on an amount of uplink data available for transmission being equal to or higher than a threshold value.
